(19) United States
(12) Patent Application Publication
(10) Pub. No.: US 2008/0052154 A1
(43) Pub. Date: Feb. 28, 2008

(54) Advertising system

(76) Inventor: Fred Kenneth Gulliksen, Fredrikstad (NO)

Correspondence Address: WENDEROTH, LIND & PONACK, L.L.P., 2033 K STREET N. W., SUITE 800, WASHINGTON, DC, 20006-1021, US

(21) Appl. No.: 11/509,635

(22) Filed: Aug. 25, 2006

(51) Int. Cl. G06Q 30/00

(52) U.S. Cl. 705/14

(57) ABSTRACT

A system and method for controlling display of advertisements in a communication network. The system comprises a central system comprising a central server, a central database and a control module controlling ordering and time scheduling of advertisements to be displayed in advertisement campaigns in a digital medium, wherein each advertisement has assigned a time schedule dedicated to at least one advertisement campaign in which the advertisement is to be displayed. The method provides display of advertisements in an advertisement campaign in a digital/electronic medium based on a time schedule associated with said advertising campaign, said time schedule controlling which advertisement in said campaign that is to be displayed in said digital medium at a given time. A short time advertisement system is also described.

### INTRODUCTION

The present invention concerns a method and a system for controlling display of advertisements in a communication network, which provides a method and a system for time limited reservation/purchase/contracts of advertising space for buyer and seller on digital marked places. A short time advertisement system is also described.

### BACKGROUND

Today's advertising systems are based on contracts with long time frames. Also, popular websites often have many advertisers queuing to get their ads displayed on the web site to reach a large marked for their products. The waiting time is often long and the price for the ad often so high, due to the number of users of the web site, that many advertisers are hindered from placing their ad on the site.

There are mainly five known ways of paying for an advertisement:
1. Payment for each click on the ad.
2. Payment for each display of the ad.
3. Payment for period (year, month, week or day).
4. Payment for each user seeing the ad.
5. Auction, where the advertiser provides time or maximum price related when the product is to be sold.

The web sites sell advertising space for periods of one day (24 hours), one week or one month, where the advertisement is shown through the whole period on the web site. Advertisers have different target groups/market segments and may have the need to advertise at different times of the day, e.g. at lunch time, evening etc. Also, advertisers may have no desire or capability to spend large amounts of money on advertising on a web site having many users.

One way of increasing the capacity in the known systems is to increase the number of advertising places. This may lead to decreased use of the website if the number of advertisements are too large compared to what the users desire. Web sites also have limited space on their web sites and have therefore provided a limit for the space to be occupied by advertisements on their main page and sub-pages and sections.

U.S. Pat. No. 6,009,409 provides a sophisticated algorithm for scheduling and controlling delivery of advertisements in a communication network. The algorithm is complex and is a function of user frequency, desired time frequency and desired geometry. Advertisements may according to this algorithm share advertising space according to calculations made by the invention and may be intermittently displayed on terminals of different users according to statistics.

### SUMMARY OF THE INVENTION

Common for the state of the art systems is that they do not provide an opportunity for short time contracts, i.e. contracts for time intervals less than 24 hours. This provides limited opportunities for creating interaction between the buyer and seller of these advertisements in real time.

The known systems also provide limited flexibility as the advertisement is presented at all times, also at times of the day which are not effective as regards the target group for the ad.

In a first aspect the invention provides a system for controlling display of advertisements in a communication network, comprising a central system comprising a central server, a central database and a control module controlling ordering and time scheduling of advertisements to be displayed in advertisement campaigns in a digital medium, wherein each advertisement has assigned a time schedule dedicated to at least one advertisement campaign in which the advertisement is to be displayed.

A unique code may be provided in each advertisement campaign in each digital medium in which advertisements are to be displayed according to the time schedule. In a further embodiment a number of zone servers may be connected to the central server through a communications network, said zone servers being controlled by the central server, and wherein said zone server having assigned at least one advertising campaign for a digital medium. Further, said zone server may comprising at least one advertising campaign comprising advertisements and time scheduling data associated with each advertisement in said campaign, said advertising campaign, advertisements and time scheduling data being uploaded from the central server.

Each advertisement may be displayed in a browser/electronic view through said digital medium enabled by said code providing a pointer to a particular advertisement campaign. Said time schedule comprises date and time information, wherein said time is divided into hours, minutes and seconds, and wherein said time schedule controlling display of the advertisements in the advertising campaign on the date and time provided by the time schedule.

In a second aspect the invention provides a method for controlling display of advertisements in a communication network, wherein said method comprises is displaying advertisements in an advertisement campaign in a digital/electronic medium based on a time schedule associated with said advertising campaign, said time schedule controlling which advertisement in said campaign that is to be displayed in said digital medium at a given time.

Said time schedule may comprise date and time information, said time information comprising hours, minutes and seconds, enabling display on said advertisement in an ordered number of time given by date, hour, minutes and seconds.

A unique code may be provided in each advertisement campaign field as displayed in a digital medium, said code providing a pointer to a particular advertisement campaign for a browser/electronic view.

In a third aspect the invention provides a short time advertisement system comprising at least one advertising campaign, said advertising campaign comprising at least one digital/electronic advertisement with assigned time schedule, said time schedule controlling display of said advertisement in a digital/electronic medium of the advertising campaign according to date and time in said time schedule. Said time may be divided into hours, minutes and seconds.

The seller provides an advertising space on an electronic site and provides the space to be sold with a special code. This provides a buyer with the opportunity to order time for displaying the advertisement by browsing through a time schedule for available time. When the buyer has selected the desired time(s), payment will be enabled through the electronic system.

The seller receives the advertisement in electronic form and sends the advertisement through an approval procedure. If the advertisement fulfils the requirements set by the electronic web site, the advertisement is approved and will be displayed according to the time selected. The advertisement is stored on a zone server connected to the central system and displayed on the electronic medium of the seller. Storage of the advertisement in the central system of the provider of this electronic advertisement service also provides the possibility of placing the advertisement on a number of electronic sites and media without storing the advertisement on the site or media itself.

By offering advertisement space for a limited time less than one day (24 hours), e.g. an hour, or even 15 minutes, and seconds, and provide the opportunity as to when during the 24 hours the advertisement is to be displayed on a web site, the advertiser will have reduced expenses on the advertisement and the advertise may be displayed in the core time for the marked segment of the ad. An example is displaying an ad for fast food during lunch time. It also provide and opportunity for advertisers to market their product during a short time on a web site with a high number of users, or to market their products in many medias or web sites at the same time, without spending a large amount of money.

The invention provides a simple solution with online and real time ordering and payment of the advertising space.

### BRIEF DESCRIPTION OF DRAWINGS

Embodiments of the invention will now be described with reference to the following drawings, where

FIG. 1 illustrates an exemplary communications network using Internet according to an embodiment of the present invention,

FIG. 2 is a box diagram illustrating the main components/participants of the advertising system according to an embodiment of the invention,

FIG. 3 shows a flowchart for a campaign registration by a seller according to an embodiment of the invention,

FIG. 4 shows a flow chart for buying advertising space available on a web site registered in the advertising system according to an embodiment of the invention,

FIG. 5 shows a flow chart for buying advertising space as in FIG. 4, but showing less technical details of the buying process, and

FIG. 6 shows the steps in an approval process for approval of an advertisement according to an embodiment of the invention.

### DETAILED DESCRIPTION

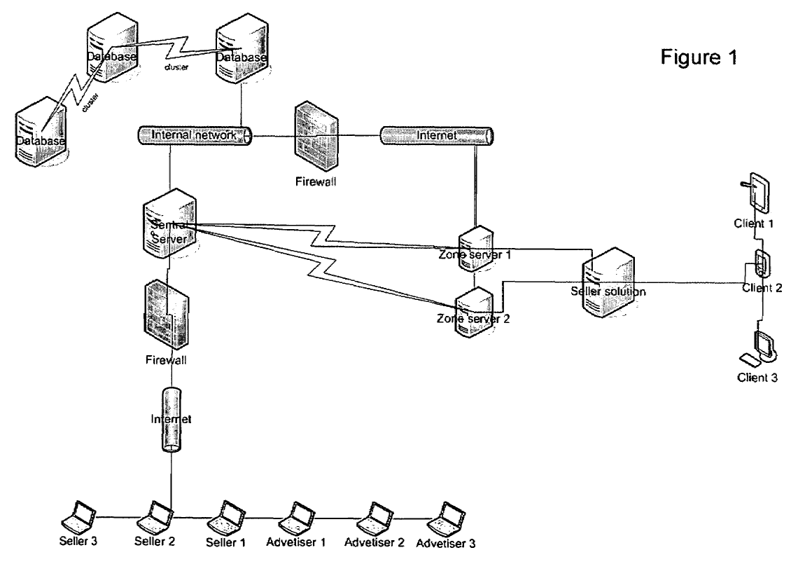

FIG. 1 illustrates an exemplary embodiment of the present invention using the Internet as communication protocol. A central system comprising a central server, an internal network and a database cluster is connected to Internet through firewalls. The central system interacts with a number of zone servers (zone server 1 and zone server 2 in FIG. 1, but the number of zone servers may vary) connected to the central system through the Internet. An advertising site (seller solution in FIG. 1) interacts with zone server 1 in FIG. 1, but a number of zone servers may be dedicated to an Internet site/web page. Client 1, 2, 3 illustrates users viewing an advertisement placed on a web page they are visiting. Advertisers 1, 2, 3 wanting to buy an advertisement space on a web page, and sellers 1, 2, 3 wanting to sell advertising space on their web page(s), connects to the central server in the central system through Internet. The different functions of the network components will be detailed below.

In the following description the words advertising campaign and advertisement will be used as separate entities. By advertising campaigns are meant advertising space/field on e.g. a web page offered for sale by the owner of the web page. The advertising campaign that may be bought by a number of advertisers wanting to advertise, may be specified to last a given time provided by dates and clock time down to hours, minutes and seconds. An advertisement campaign may therefore contain many different advertisers from different buyers. Each advertisement is ordered to be displayed in said field/space on e.g. the web page according to selected date and time by the buyer.

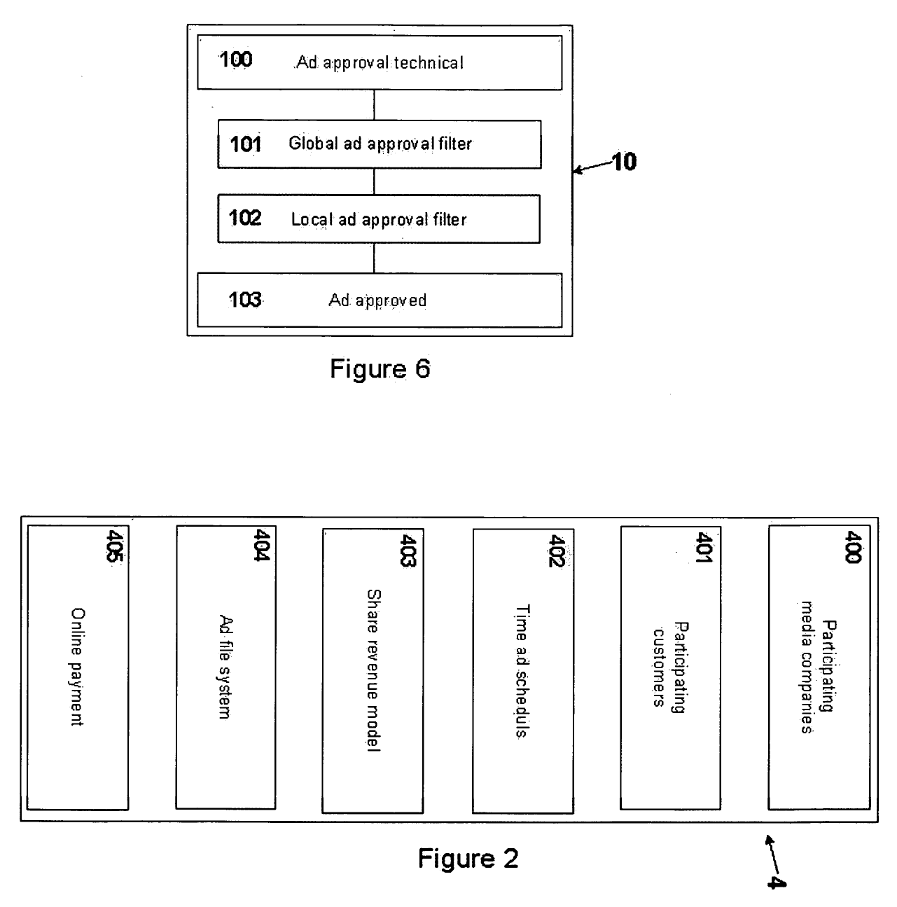

The central database cluster contains all information regarding sellers, advertisers, advertising campaigns, time ad schedules and advertisements. This will be explained in relation to FIG. 2 below. The central server controls payment and controls the advertising process and zone servers. The zone servers provide an interface with the seller solutions, e.g. web sites, and approved advertisements with allocated time schedule for display is downloaded to the zone server from the central database cluster under control of the central server. A client 1, 2, 3 (user of e.g. Internet) through any PC or handheld device (e.g. PDA, mobile phone) accesses the web site of the seller. The client browser downloads the correct advertisement from the zone server, via a code (e.g. HTML code) on the seller's web site providing a link to a particular advertising campaign. Each advertising campaign has assigned a directory comprising a time schedule with allocated file names for the advertisements in said campaign. A file name is allocated for each second in the time schedule. Display of an advertisement in a digital medium, e.g. a mobile phone, are thereby controlled by the time schedule. The digital medium provides the correct local time. Based on local date and time, the time schedule provides a file name, and thereby an advertisement is selected for display on the mobile phone.

The interface for ordering an advertisement campaign and ordering advertisement space is stored in the central system, and accessed by connecting to the central server through a communication network, e.g. Internet.

It is also possible to provide a solution without zone server, where the central server itself provides an interface to the digital/electronic medium. Other forms of communication networks and protocols may be used, e.g. wireless networks, LANs, WANs, telephone networks, mobile networks etc.

FIG. 2 illustrates the main components and participants of the advertising system. All the sellers (participating media companies 400) of advertising space must be registered in the central system. The participating media companies are registered in the system by company, organisation number, email, telephone, home page, address information and invoice address information. In addition, a unique ID is assigned to each media company (seller) by the central system. Each media company must also decide a number for global and local numerical values. The global and local values are used in the approval process of advertisement to be placed in available advertising space on web sites belonging to the media company, and may provide automation of the approval process. A seller/media company creates time limited advertising campaigns on their web sites and sells the available space through the advertising system.

Participating customers 401 register in the central system or through the sellers' 400 web sites providing links to the central system. The participating customers are registered with metadata necessary to perform a transaction. These metadata include company name, organisation number, email, telephone, home page, address information, credit card number and invoice address information.

All advertising campaigns in the advertising system are uniquely associated with a time schedule defining the beginning and the end of each advertising campaign. Each minute of the campaign period is defined and each minute is buyable by buyers wanting to place advertisements in the campaign space. Placing of a particular advertisement is ordered for a certain number of minutes in the central systems. All this information is provided in a time ad schedule 402 controlled by the central system and stored in the database cluster of the central system. Each particular advertisement and its time schedule are loaded from the central system and to a particular zone server dedicated for the particular web site it is to be displayed.

Share revenue model 403 provides a seller with share of revenue for buyers which initially have accessed the advertising system through their web site, when these buyers order advertising space belonging to other sellers connected to the system.

All the advertisements are produced and approved by the central system and stored in an ad file system 404 on the database cluster in the central data system. When an advertisement has been approved (the approval procedure will be explained later) and paid for by a buyer of advertising space in an advertising campaign, the advertisement is loaded to a particular zone server dedicated for the particular web site it is to be displayed.

The central system also comprises as mentioned above an online payment module 405 allowing online charging of credit cards. An amount is reserved when an advertisement has been bought, and finally charged only after approval of the advertisement by the seller of campaign space on a web site.

### Advertising Campaign Registration

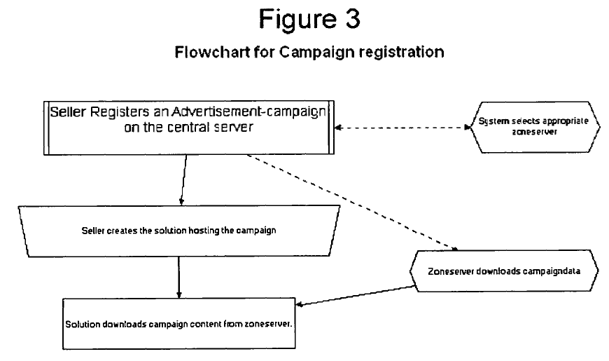

A flowchart for registration of an advertisement campaign is shown in FIG. 3. An advertising campaign in this context means a seller registering a particular advertising space on a web site for sale in a specified time interval through the advertisement system of the present invention.

According to FIG. 3, the seller registers the advertisement campaign on the central server by connecting to the server through Internet. The central system selects the appropriate zone server hosting this particular campaign and stores this information in the database cluster. The seller creates the campaign and publishes it for potential customers. The campaign data is downloaded from the central system to the zone server. The seller offering advertising space will then download the campaign data from the zone server. When an internet user is viewing the web site, downloading of the advertising space may be effectuated by using a pointer (HTML-code) provided in said advertising space. The advertising space will be displayed as available space in the time intervals which not yet has been bought by buyers.

### Advertisement Registration

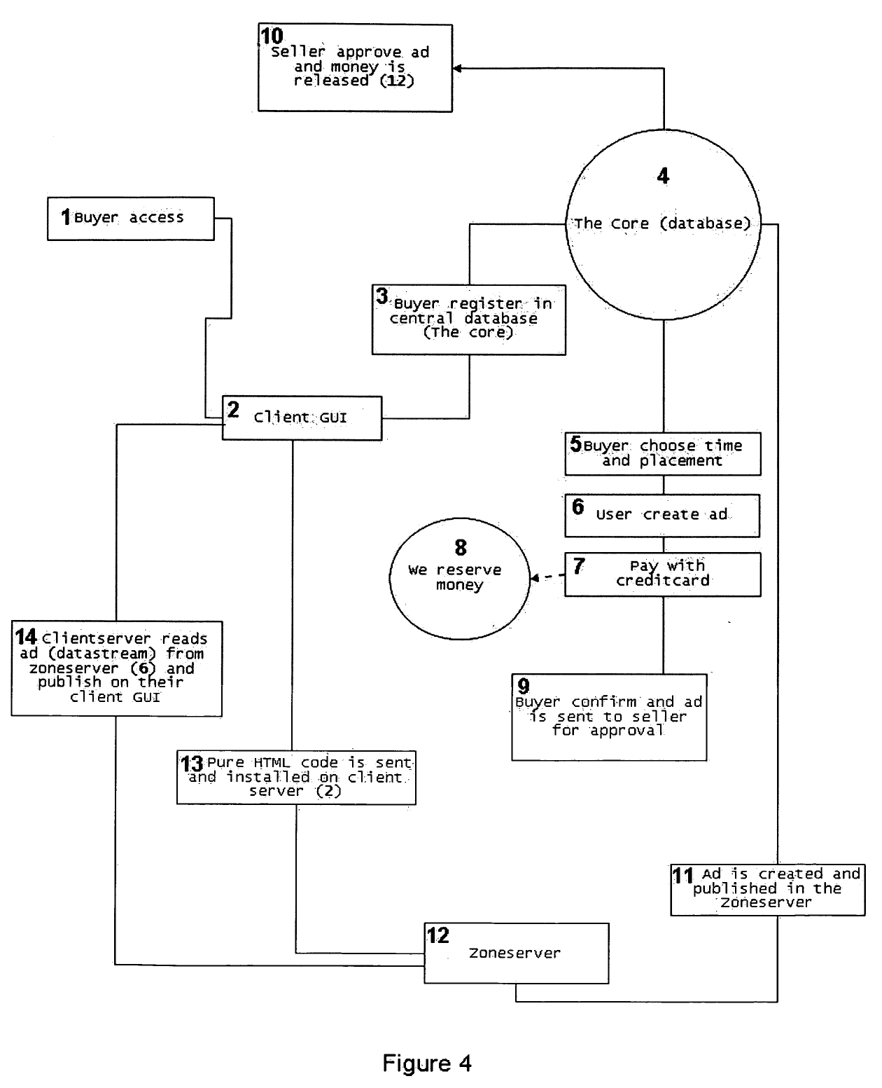

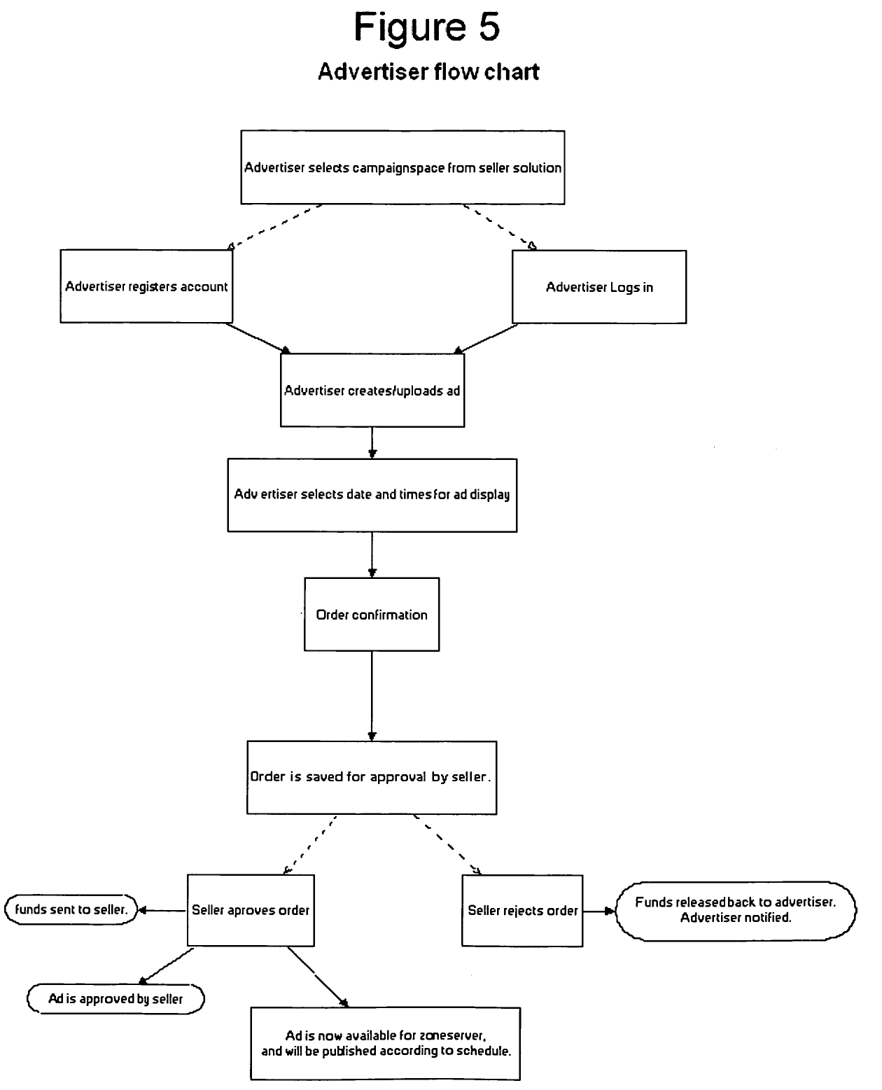

A flowchart for buying advertisement space is shown in FIG. 5. FIG. 4 is an additional flowchart for an advertisement buying process showing more of the technical details.

The seller 2 of an advertising space, i.e. a client in FIG. 4, is provided with a GUI (graphical user interface) in a digital medium, e.g. e web site on the internet. The advertising spaces to be sold by the system of the present invention are provided with a link to the central advertising system.

A buyer of advertising space for a particular advertisement accesses 1 the central advertising system through the seller GUI 2, e.g. by clicking on the desired advertising space. This provides opening of an interface interacting with the central system of the advertising system. The potential buyer registers 3 through said interface in a central database 4 in the central system. The registration details are explained earlier in relation to FIG. 2.

The buyer browses through a time schedule for available time for the particular advertising space and selects 5 the time for graphically display of the advertisement. The advertisement may be in any digital form e.g. text, image, film, audio etc. The advertisement is created 6 in the central system or downloaded to the central system. When the advertisement is downloaded and stored in the central system, payment of the advertisement is provided online. A specific amount of money is reserved 8 from the buyer's credit card 7 or other forms of online payment and confirmed by the buyer, before the advertisement is forwarded 9 to the seller of the advertisement space for approval. This forwarding may be performed through the internet. The approval procedure will be explained later with reference to FIG. 6.

If the advertisement is approved 10 by the seller, the payment is released 12 and transferred from the reservation account in the central database to the seller account in the central database. The advertisement is then created in a suitable form for the electronic publication medium and stored (published) 11 on a zone server 12 dedicated for that particular web site. When an internet user views the web site, the user's browser reads the HTML code provided in the advertising space by the central system. The HTML code provides a link to the zone server where the particular advertisement campaign with associated time schedule and advertisements is stored, and displays the correct advertisement according to the time schedule. As the user's browser reads 14 the advertisement data stream from the zone server and publishes the advertisement on the GUI of the seller, as explained above, the seller server does not process the advertisements and time schedule of an advertising space. The processing is handled by the user's browser.

To summarize by referring to FIG. 5, an advertiser selects campaign space from seller solution. Advertiser registers an account in the central system as explained earlier, or if already registered, logs in. Advertisement is created or uploaded to the central system, and date and time for advertisement display selected. Order is confirmed, and order is saved for approval by the seller. If the seller approves the advertisement, an amount withdrawn from the advertiser's credit card is transmitted to seller. The advertisement is downloaded to a zone server and will be published according to schedule. If the seller of advertisement space (advertiser campaign owner) rejects the advertisement, the amount withdrawn from the advertiser's account is refunded and advertiser notified about the rejection of the advertisement.

### Approval Procedure 10

The approval procedure 10 is illustrated in FIG. 6. The advertisement desired to be placed on a web page by an advertiser, may either go through an approval procedure in the central system or be approved by a seller of advertisement space connected to the central system. The approval procedure the central system will be explained here, but the same procedure may be performed in a seller system.

The advertisement is put in line 100 for approval. The central system checks, by querying against a database in the database cluster, whether the advertisement has been approved by other sellers 400 connected to the advertising service of the present invention.

If an advertisement has been approved earlier by any seller of advertisement space connected to the central system, the advertisement will have assigned a numerical value corresponding to the number of times it has been approved earlier. If this value is higher than a global value set by the seller of advertising space for this particular web site, the advertisement will be automatically approved, and an amount debited the buyer's credit card account 401. If the global value is less than the value set by the seller of the advertising space, the numerical value is checked against a local demand value 101. If the seller 400 of this particular advertising space has approved earlier advertisements from this particular advertiser, the number of such earlier approvals will be checked by querying against a database in the central system. If the numerical value is higher than the local demand value, the advertisement is automatically approved, and an amount debited the buyer's credit card account 401. If the numerical value is less than the local demand value, the advertisement is sent to the seller of this particular advertisement space for manual approval. When an advertisement is approved, both the global value and the local value is increased and transmitted to the central database cluster and stored for later use.

Having described preferred embodiments of the invention it will be apparent to those skilled in the art that other embodiments incorporating the concepts may be used. These and other examples of the invention illustrated above are intended by is way of example only and the actual scope of the invention is to be determined from the following claims.

1. System for controlling display of advertisements in a communication network, comprising:
central system comprising a central server, a central database and a control module controlling ordering and time scheduling of advertisements to be displayed in advertisement campaigns in a digital medium, wherein each advertisement has assigned a time schedule dedicated to at least one advertisement campaign in which the advertisement is to be displayed.

2. System according to claim 1, wherein a unique code is provided in each advertisement campaign in each digital medium in which advertisements are to be displayed according to the time schedule.

3. System according to claim 1, comprising a number of zone servers connected to the central server through a communications network, said zone servers being controlled by the central server, and wherein said zone server having assigned at least one advertising campaign for a digital medium.

4. System according to claim 3, wherein said zone server comprising at least one advertising campaign comprising advertisements and time scheduling data associated with each advertisement in said campaign, said advertising campaign, advertisements and time scheduling data being uploaded from the central server.

5. System according to claim 2, wherein each advertisement is displayed in a browser/electronic view through said digital medium enabled by said code providing a pointer to a particular advertisement campaign.

6. System according to claim 1, wherein said time schedule comprises date and time information, wherein said time is divided into hours, minutes and seconds, said time schedule controlling display of the advertisements in the advertising campaign on the date and time provided by the time schedule.

7. Method for controlling display of advertisements in a communication network, said method comprising:
displaying advertisements in an advertisement campaign in a digital/electronic medium based on a time schedule associated with said advertising campaign, said time schedule controlling which advertisement in said campaign that is to be displayed in said digital medium at a given time.

8. Method according to claim 7, wherein said time schedule comprising date and time information, said time information comprising hours, minutes and seconds, enabling display on said advertisement in an ordered number of time given by date, hour, minutes and seconds.

9. Method according to claim 7, comprising providing a unique code in each advertisement campaign field as displayed in a digital medium, said code is providing a pointer to a particular advertisement campaign for a browser/electronic view.

10. Short time advertisement system comprising at least one advertising campaign, said advertising campaign comprising at least one digital advertisement with assigned time schedule, said time schedule controlling display of said advertisement in a digital medium of the advertising campaign according to date and time in said time schedule.

11. System according to claim 10, wherein said time being divided into hours, minutes and seconds.
